(19) United States
(12) Patent Application Publication
(10) Pub. No.: US 2026/0206677 A1
(43) Pub. Date: Jul. 23, 2026

(54) LOOK-AHEAD CALIBRATION AND OUT-OF-CALIBRATION DETECTION OR RESPONSE FOR SECTIONAL CONTROL TECHNOLOGY OF AN AIR SEEDING APPARATUS

(71) Applicant: VADERSTAD INDUSTRIES INC., Langbank (CA)

(72) Inventor: Carter BOHN, Yorkton (CA)

(73) Assignee: VADERSTAD INDUSTRIES INC., Langbank, SK (CA)

(21) Appl. No.: 19/102,234

(22) PCT Filed: Aug. 2, 2023
(86) PCT No.: PCT/CA2023/051033

§ 371 Date: Feb. 7, 2025

Related U.S. Application Data
(60) Provisional application No. 63/398,594, filed on Aug. 17, 2022.

(51) Int. Cl. A01C 7/10; A01C 7/08

(52) U.S. Cl. CPC A01C 7/107; A01C 7/088

(57) ABSTRACT

A method and related system are provided for look-ahead calibration of sectional control technology of an air seeding apparatus used to deposit particulate material on the ground, to account for time required by particulate material (e.g., seed or fertilizer) to travel through distribution paths after engagement and disengagement of metering devices that dispense the particulate material from a container into the distribution paths. The method is performed by a computer that controls the metering devices to start and cease dispensing particulate material through the distribution path, measures elapsed times until a flow sensor starts and stop detecting particulate material flow through the distribution path, and modifies a stored sectional control algorithm based on the elapsed times. A method and system detect or respond to out-of-calibration operation of the air seeding apparatus if elapsed engage or disengage times deviate from stored engage or disengage times that define the sectional control algorithm.

### FIELD OF THE INVENTION

The present invention relates to calibration of sectional control technology of an air seeding apparatus used to deposit particulate material in the ground, to account for time required by particulate material to travel through distribution paths after activating and deactivating metering devices. The present invention also relates to detecting and responding to out-of-calibration operation of sectional control technology of an air seeding apparatus.

### BACKGROUND OF THE INVENTION

Air seeding apparatuses for depositing particulate material (e.g., seed, fertilizer, inoculants, or other seed and plant treatments) in the ground include metering devices that dispense particulate material from a container into distribution paths having outlets at different transverse locations of a toolbar. Typically, the metering devices are transversely aligned with centerline of the toolbar, and therefore, the longest distribution paths have outlets that are farthest from the centerline of the toolbar.

These distribution paths can have lengths of several meters (e.g., 5 m to 40 m), and the particulate material can take from a few to several seconds to travel through the distribution paths after the metering devices are “engaged” (i.e., activated to dispense particulate material) or “disengaged” (i.e., deactivated to stop dispensing particulate material). This travel time will be longer for longer distribution paths than shorter ones, because the particulate material travels at approximately the same speed through all distribution paths.

Sectional control technologies (SCTs) use a computer to control the metering devices based on position data (e.g., from a GPS device) of the air seeding apparatus so that the particulate material is applied in a manner that is efficient and optimal for crop growth. Specifically, SCTs are used to avoid overlaps—i.e., depositing particulate material on ground where particulate material was previously deposited.

The accuracy of SCTs can be improved by “look-ahead” calibration to account for travel time of the particulate material in the distribution paths. This requires two key parameters: the engage time; and the disengage time. The “engage time” is the expected elapsed time from engaging the metering device until particulate material starts flowing out of the distribution path outlets. The “disengage time” is the expected elapsed time from disengaging the metering device until particulate material stops flowing out of the distribution path outlets. Once the SCT is calibrated using the engage time (and disengage time), it can engage (or disengage) metering devices before the air seeding apparatus reaches a border between unseeded ground and seeded ground (or vice versa) so that seed will start (or stop) flowing out of the distribution path outlets upon arriving at the border, rather than afterwards.

An existing approach to look-ahead calibration requires a human operator to provide manual inputs to a computer in reaction to observing the start and cessation of particulate material flow out of the distribution path outlets after the metering devices are engaged and disengaged, respectively. This approach can be used to calibrate multiple distribution paths of differing lengths on an individual basis, but doing so is time-consuming. Therefore, in practice, this approach is performed on a simplified basis by requiring the operator to provide manual inputs only in response to observing the start of particulate material flow out of the longest distribution path, and cessation of particulate material flow out of the shortest distribution path. Based on these inputs, the computer determines the engage and disengage times, and uses them to modify a stored algorithm that governs the SCT.

This approach, however, is susceptible to human error and variability in judgment and reaction time. Further, the human operator must be able to see the flow of particulate material out of the distribution path outlets, and this is usually not possible from the cab of a vehicle towing the air seeding apparatus. Therefore, this approach is not convenient to perform while the operator is using the air seeding apparatus in the field. Further still, this approach performed on a simplified basis results in excessive engage times for shorter distribution paths. This causes the SCT to prematurely engage their associated metering devices. FIG. 12 shows the result after toolbar 22 has travelled across a border 80 from previously seeded ground to unseeded ground. Premature engagement of metering devices associated with the shorter distribution path results in undesirable overlap of deposited particulate material in region 82, in addition to the expected deposition of particulate material in region 84.

Once look-ahead calibration of the SCT has been performed, the SCT may operate “out-of-calibration” during use. That is, the time that the particulate material takes to actually start or cease flowing out of the distribution path outlet after engaging or disengaging the metering device may differ from the expected engage time or disengage time that defines the stored section control algorithm. Significant variances may be indicative of an operational problem with the air seeding apparatus, and the need to recalibrate the SCT or modify the operation of the air seeding apparatus to account for such variances. Another reason for variances could arise when changing the use of the product bins. Different products have varying acceptable airspeeds, thus, when the product in a bin is changed, a recalibration may be needed.

There remains a need in the art for more convenient look-ahead calibration of SCTs, and for detecting and responding to out-of-calibration operation of SCTs.

### SUMMARY OF THE INVENTION

In a first aspect, the present invention comprises a method for look-ahead calibration of a stored sectional control algorithm for an air seeding apparatus comprising at least one metering device for dispensing particulate material from a container through an associated distribution path to at least one associated flow sensor. In embodiments, the at least one metering device may comprise a plurality of metering devices, wherein each of the metering devices is for dispensing particulate material from the container through a different associated distribution path to a different associated flow sensor. The method is implemented by a processor operatively connected to the metering device and the flow sensor. The method comprises the steps of: (a) controlling the metering device to start dispensing particulate material through the distribution path; (b) measuring an elapsed engage time from step (a) until the flow sensor starts detecting particulate material flow above a starting threshold flow value; (c) controlling the metering device to cease dispensing particulate material through the distribution path; (d) measuring an elapsed disengage time from step (c) until the flow sensor starts detecting particulate material flow below a stopping threshold flow value; and (e) modifying the stored sectional control algorithm based on the engaged time and the disengage time. In embodiments of the method, the method comprises performing steps (a) to (e) in respect to each of a plurality of the metering devices.

In a second aspect, the present invention comprises a method for detecting or responding to out-of-calibration operation of an air seeding apparatus comprising a metering device for dispensing particulate material from a container through an associated distribution path to a flow sensor, where the metering device is controlled by a stored sectional control algorithm defined by a stored engage time or a stored disengage time indicative of expected travel time for particulate material through the distribution path after engaging the metering device, or disengaging the metering device, respectively. The method is implemented by a processor operatively connected to the metering device and the flow sensor. In one embodiment, the method comprises the steps of: (a) measuring an elapsed engage time from when the sectional control algorithm engages the metering device to start dispensing particulate material through the distribution path until the flow sensor detects particulate material flow above a starting threshold flow value; and (b) if the stored engage time and the elapsed engage time deviate from each other by more than a first threshold deviation value, taking a related action. In another embodiment, the method comprises the steps of: (a) measuring an elapsed disengage time from when the sectional control algorithm disengages the metering device to cease dispensing particulate material through the distribution path until the flow sensor detects particulate material flow below a stopping threshold flow value; and (b) if the stored disengage time and the elapsed disengage time deviate from each other by more than a second threshold deviation value, taking a related action. In embodiments, the related action may comprise generating a visible alert on a display screen, or varying a speed of a fan for creating air flow through the distribution path. It is understood, however, that there may be situations where the operator may prefer to maintain the operating conditions when receiving an alert rather than vary the fan speed. Hence, in these situations, the related action could also be that, together with the visual alert, the operator has the option to update the stored values to the present values.

In a third aspect, the present invention comprises a system for look-ahead calibration using the stored sectional control algorithm, and/or for detecting or responding to out-of-calibration operation of an air seeding apparatus. The system comprises a processor operatively connected to the metering device and the flow sensor. The system also comprises a non-transitory computer readable medium storing a set of instructions executable by the processor to implement the method(s) (and embodiments thereof) of any one or a combination of the first and second aspects as described above. In embodiments, the system also comprises the flow sensor.

In a fourth aspect, the present invention comprises a computer program product for look-ahead calibration of the stored sectional control algorithm and/or for detecting or responding to out-of-calibration operation of an air seeding apparatus. The computer program product comprises a non-transitory computer readable medium storing a set of instructions executable by a processor operatively connected to the metering device and the flow sensor to implement the method(s) (and embodiments thereof) of any one or a combination of the first and second aspects as described above.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a top plan view of an embodiment of an air seeding apparatus and a computer used to implement a SCT and look-ahead calibration method of present invention.

FIG. 2 is a functional block diagram of an embodiment of a computer that implements a look-ahead calibration method of the present invention, in relation to parts of an air seeding apparatus.

FIGS. 3A and 3B are collectively a flowchart for an embodiment of a look-ahead calibration method of the present invention. FIG. 3A is a first part of the flow chart. FIG. 3B is a second part of the flow chart continuing from FIG. 3A.

FIG. 4 is a flow chart for a subroutine for defining starting and stopping threshold values of the flow of particulate material that are used in the method of FIGS. 3A and 3B.

FIGS. 5-8 show a tablet computer displaying a sequence of graphical user interfaces (GUIs) for a human operator to supervise certain steps of the look-ahead calibration method of FIGS. 3A and 3B.

FIG. 5 shows a GUI for an operator to commence the look-ahead calibration method.

FIG. 6 shows a GUI for an operator to select a container.

FIG. 7 shows a GUI for an operator to command priming of metering devices.

FIG. 8 shows a GUI displaying engage time and disengage time results, and an interface for modifying and accepting these results.

FIG. 9 shows a flowchart for an embodiment of a method for detecting and/or responding to out-of-calibration operation detection method of the present invention, based on a deviation between calibrated and measured engage times.

FIG. 10 shows a flowchart for an embodiment of a method for detecting and/or responding to out-of-calibration operation detection method of the present invention, based on a deviation between calibrated and measured disengage times.

FIG. 11 shows a GUI for alerting an operator of an out-of-calibration operation of an air seeding apparatus detected by the method of FIG. 9 or FIG. 10, and for adjusting fan speed.

FIG. 12 shows a toolbar and areas of ground where particulate material has been deposited by an air seeding apparatus having a sectional control technology calibrated for look-ahead in accordance with a prior art approach.

FIG. 13 shows a prior art metering device assembly having a plurality of metering devices, in relation to a container and distribution paths.

### DETAILED DESCRIPTION OF EMBODIMENTS OF THE INVENTION

### Definitions

The invention relates to look-ahead calibration of a sectional control technology (SCT) of an air seeding apparatus that deposits particulate material on the ground, and to detecting and responding to out-of-calibration operation of the air seeding apparatus. Any term or expression not expressly defined herein shall have its commonly accepted definition understood by a person skilled in the art. As used herein, the following terms have the following meanings.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

“Particulate material” refers to any material in granular form that may be deposited on the ground for growing crops. Particulate material includes seeds, fertilizer, inoculants, and other seed or crop treatments in granular form.

“Distribution path” refers to any physical passage(s) for flow of particulate material. As a non-limiting example, a distribution path may comprise a portion or all of the passage(s) between a metering device and a seed or fertilizer dispensing outlet of a ground opening tool. A distribution path may be made up of one or more hoses, towers, feed tubes, and/or other types of passages.

“Metering device” refers to any electro-mechanical, ground driven or hydraulically driven device that can be controlled by an operatively connected processor to selectively dispense particulate material into a distribution path associated with the metering device. The present invention may be implemented with a variety of metering devices known in the art. As non-limiting examples, metering devices may include a flow controller such as a roller or an auger that can be selectively rotated to dispense particulate material into a distribution path.

“Stored sectional control algorithm” refers to a set of instructions stored on a memory, which instructions are executable by a processor to control the timing of operation of one or more metering devices, based on a geographic position of an air seeding apparatus, or a part attached thereto such as a vehicle towing the air seeding apparatus.

“Flow sensor” refers to any electromechanical device that is operable to provide a signal that can be processed by a processor to indicate flow (or absence thereof) and/or the flow rate of particulate material. The flow sensor can be directly or indirectly indicative of the flow, for example, sensing the actual flow of the particulate material, changes in air pressure, and the like. In one embodiment, the flow sensor may use an acoustic sensor to detect sound waves generated by impact of particulate material against an impact surface in a particulate flow path. In other embodiments, the flow sensor may be implemented with a variety of other types of sensors known in the art.

### System

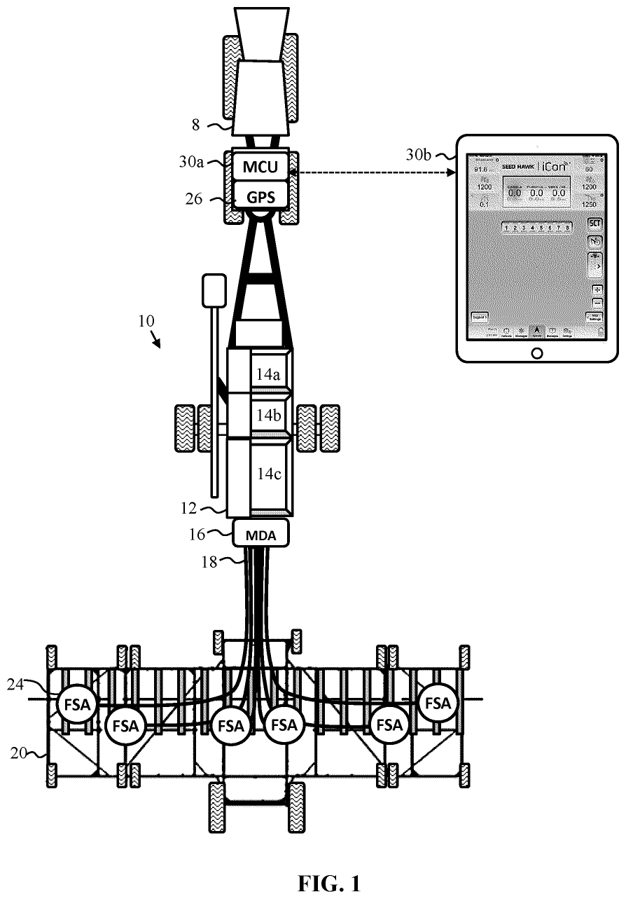

FIG. 1 shows an embodiment of an air seeding apparatus 10 including a wheeled air cart 12 attached to a tow vehicle 8, such as wheeled or tracked tractor.

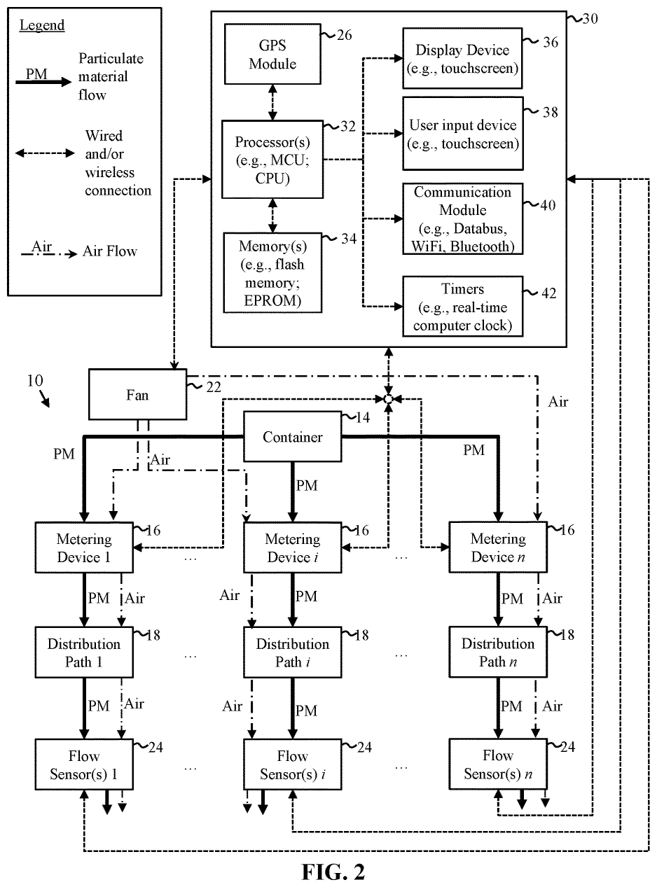

Air cart 12 has at least one container 14 (and in this embodiment, three separate containers 14a, 14b, 14c) for storing particulate material. Each container 14 is associated with a different metering device assembly (MDA), having a plurality metering devices 16. Each metering device 16 receives particulate material from an outlet of the containers 14, and dispenses particulate material through one of multiple distribution paths 18 (e.g., hoses) that extend to one of a six towers located at different sections of a wheeled toolbar 20. While not shown, one or more electrically-controlled hydraulically powered fans (corresponding to fan 22 in FIG. 2) are present for creating air flow to drive particulate material through the distribution paths 18. The present invention is not limited by a particular type of fan or mechanism for creating such air flow.

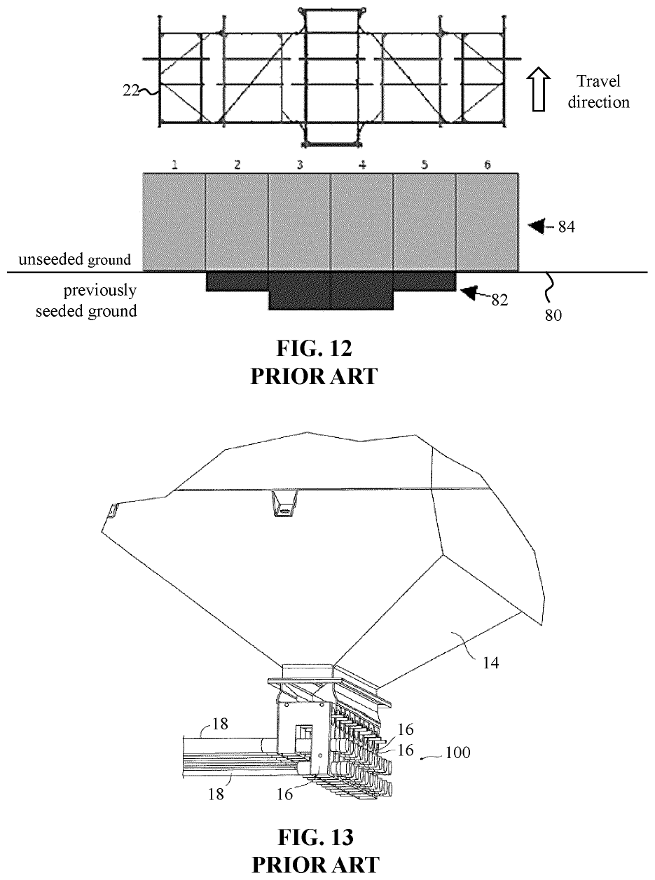

Non-limiting examples of metering device assemblies suitable for use with the present invention have a plurality of metering devices 16, with each metering device 16 having a rotatable flow controller (e.g., an auger or roller), as described in U.S. Pat. No. 8,757,073 B2 titled “Metering assembly for an air seeder” (Jun. 24, 2014; Beaujot et al.; One Pass Implements Inc.), and in U.S. patent application publication no. 2015/0216109 A1 (Aug. 6, 2015; Meyer et al.; One Pass Implements Inc.), the entire contents of which are incorporated herein by reference, where permitted. For illustration, FIG. 13 shows a metering device assembly 100 and its constituent metering devices 16, as described in U.S. Pat. No. 8,757,073 B2.

A non-limiting example of toolbar 20 is a 45-XL™ toolbar (Vaderstad North America; Langbank, Canada) having a transverse width of about 12.2 m to 25 m. (In FIG. 1, the transverse width of toolbar 20 is measured in the horizontal direction of the drawing plane.) Accordingly, the distribution paths 18 have substantially different lengths (e.g., from about 5 m to about 40 m) from their associated metering devices 16 to associated respective air seeder towers.

While not shown in FIG. 1, as known in the art, each air seeder tower has a manifold that distributes particulate material into a plurality (e.g., ten) secondary distribution paths (e.g., seed runs) that extend to one of a plurality of ground opening tools (e.g., a seed knife or fertilizer) mounted on toolbar 20. These secondary distribution paths are relatively short (e.g., from 0.5 to about 1 m), but also similar for different towers. Therefore the time for particulate material to travel through the secondary distribution paths may either be disregarded for the purpose of look-ahead calibration, or readily taken into account by a stored sectional control algorithm (e.g., by adding the expected time for the particulate material to travel through the secondary distribution path to the engage and disengage times discussed below).

In FIG. 1, a flow sensor assembly (FSA) has at least one flow sensor 24. Only one flow sensor 24 per distribution path 18 is required to implement the present invention. In this embodiment, however, FSA has ten flow sensors 24, with each flow sensor 24 being associated with one of the plurality (e.g. ten) secondary distribution paths (e.g., seed runs) extending from the tower manifold.

A non-limiting example of a flow sensor 24 suitable for use with the present invention includes a microphone to detect sound waves generated by impact of particulate material against an impact surface, as described in U.S. Pat. No. 8,950,260 B2 titled “Air seeder monitoring and equalization system using acoustic sensors” (Gelinske et al.; Feb. 10, 2015; Intelligent Agricultural Solutions, LLC), the entire contents of which are incorporated herein by reference, where permitted. In addition to being used for calibration of sectional control technology in accordance with the present invention, flow sensors 24 may be used as blockage sensors, as known in the art. Accordingly, an air seeding apparatus 10 having blockage sensors may be adapted for the present invention.

For implementing sectional control technology (SCT), air seeding apparatus 10 is associated with a GPS module 26 and a computer device. GPS module 26 may be operatively connected to or form part of the computer device. GPS module 26 includes an antenna for receiving satellite navigation signals (e.g., signals transmitted by the Global Positioning System (GPS), the Global Navigation Satellite System (GLONASS), the Galileo positioning system, the Beidou Navigation Satellite System, or other satellite navigation systems), and an operatively connected processor that is configured with a set of instructions stored on a memory, to analyze such satellite navigation signals to determine the position of the air seeder apparatus 10. Based on the position (and possibly other information such as the speed of toolbar 20), the computer device controls the engagement and disengagement of metering devices 16 in accordance with a stored sectional control algorithm, as known in the art.

In the embodiment of FIG. 1, the computer device is implemented in part by a microcontroller (MCU) 30a attached to the tow vehicle 8, and in part by a tablet computer 30b (e.g., an iPad™ (Apple Inc.; Cupertino, CA, USA)) running a software application or “app” dedicated for sectional control technology. As shown by the dashed arrow line in FIG. 1, tablet computer 30b is operatively connected with microcontroller 30a to communicate data and commands. The operative connection may include wired connection and/or wireless communication protocols known in the art, such as Bluetooth™, Wi-Fi, and the like. Tablet computer 30b may be removably mounted to the operator cab of tow vehicle 8. Tablet computer 30b may be substituted with other types of computers such as a smartphone, laptop computer, or a dashboard-mounted computer in the operator cab of tow vehicle 8. In other embodiments, the computer device may be implemented by a single physically discrete device or a greater number of physically discrete devices.

FIG. 2 shows a functional block diagram of such computer device 30, in relation to one of the containers 14, metering devices 16, distribution paths 18, and flow sensors 24 of air seeding apparatus 10. There are an integer number, n, of metering devices 16, distribution paths 18, and flow sensors 24. The number, n, may be one or greater, with the generic component denoted with the index, i. For simplicity, FIG. 2 shows only one container 14, but for air seeding apparatuses having multiple containers (e.g., containers 14a, 14b, and 14c of FIG. 1), each container 14 would have analogous relationships to analogous components of air seeding apparatus 10.

In FIG. 2, solid arrow lines labelled “PM” indicate flow paths for particulate material from container 14 to metering devices 16 to distribution paths 18 to flow sensors 24. Dash-dot lines labelled “Air” indicate flow paths for air flow created by fan 22 through metering devices 16, distribution paths 18, and flow sensors 24 to drive the particulate material through these components. Dashed arrow lines indicate operative connections by wired connection and/or wireless communication protocols known in the art, such as Bluetooth™, Wi-Fi, and the like.

Computer device 30 is operatively connected to control means (e.g., switches) to “engage” metering devices 16 (i.e., activate them to dispense particulate material from container 14 into the associated distribution path 18), and “disengage” metering devices 16 (i.e., deactivate them to stop dispensing particulate material from container 14 into the associated distribution path 18). Further, computer device 30 is operatively connected to fan 22 to control its operation (e.g., switch it “on” or “off”, and/or control power supply to the fan to control its rotational speed), and/or to receive signals indicative of its operational state (e.g., its rotational speed). Further, computer device 30 is operatively connected to flow sensors 24 to receive signals generated by them that are indicative of particulate material flow rate.

In the embodiment of FIG. 2, computer device 30 includes GPS module 26, at least one processor 32, memory 34, display device 36, user input device 38, communication module 40 and timer 42. In this example, processor 32 may include MCU 30a or CPU of tablet computer 30b. Memory 34 may include a memory associated with MCU 30a, and a solid state memory of tablet computer 30b. Memory 34 stores a stored sectional control algorithm, as well as set of instructions that can be executed by the processor 32 to implement a look-ahead calibration method of the present invention. Display device 36 may include the touchscreen of tablet computer 30b and/or other display screen that can be used to show graphical user interfaces (GUIs) when implementing certain embodiments of the method. User input device 38 may include the touchscreen of tablet computer 30b, and/or other device (e.g., keyboard or computer mouse) that allows a human operator to control implementation of certain embodiments of the method. Communications module 40 may include a wired databus and/or wireless communication module (e.g., Wi-Fi or Bluetooth module) for operative connection of the computer device 30 with metering devices 16, fan 22, and flow sensors 24. Timers 42 may be a real-time computer clock (e.g., integrated with processor 32) or another computer device, that can be used to measure elapsed time. Preferably, timers 42 are capable of measuring at a resolution of one second or less (e.g., a tenth or a hundredth of a second).

### Method for Look-Ahead Calibration

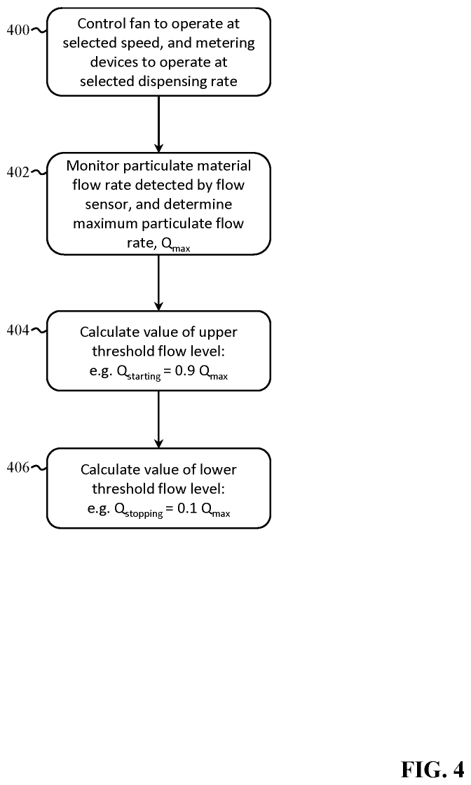

In one embodiment, the look-ahead calibration method of the present invention is initiated by an input entered by a human operator using a computer device 30. For example, tablet computer 30b displays a GUI shown in FIG. 5 with a user-selectable button labelled “Product Lookahead Calibration”. After this button has been selected, the GUI enables another user-selectable button labelled “Begin”.

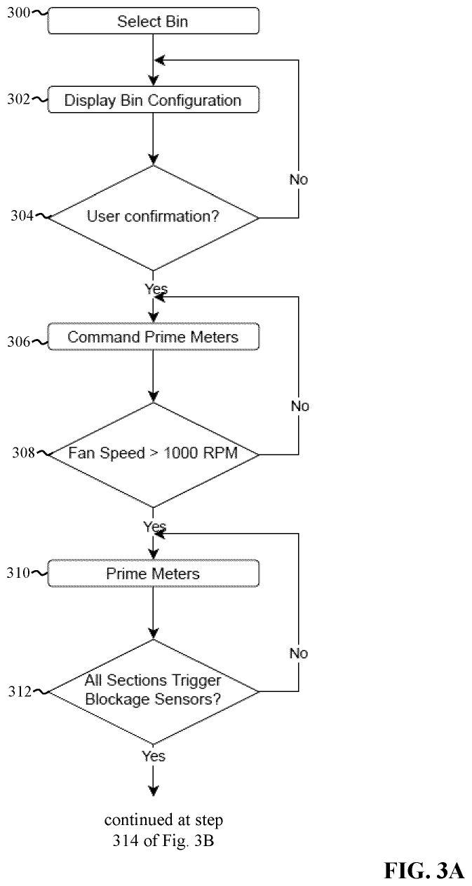

In response to this button has been selected, processor 32 executes instructions stored by memory 34 of computer device 30 to implement the look-ahead calibration method of the present invention, as shown in one embodiment in FIGS. 3A and 3B. Such instructions stored on memory 34 constitutes a computer program product of the present invention.

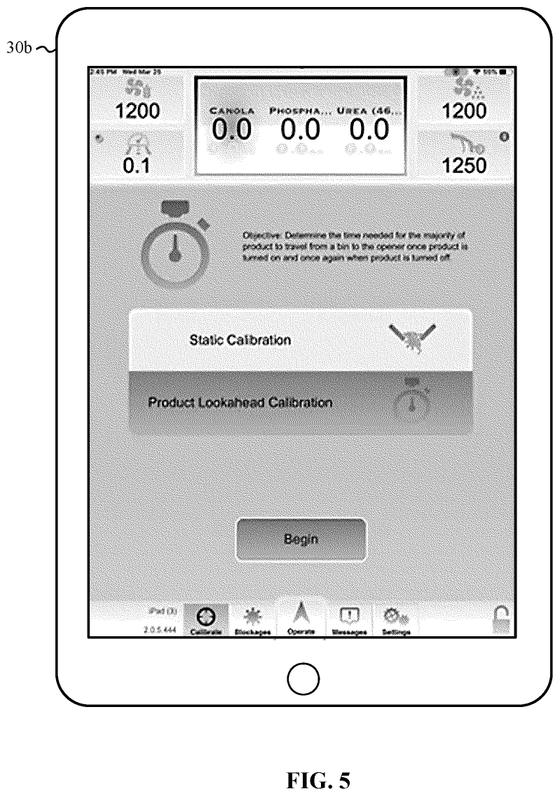

At step 300, the computer device presents the human operator with an interface for selecting one of containers 14 for look-ahead calibration. In this example, display device 36 of tablet computer 30b displays a GUI, as shown in FIG. 6, with user-selectable buttons labelled “Bin 1”, “Bin 2”, and “Bin 3”, corresponding to container 14a, 14b, 14c, respectively, of air cart 12 shown in FIG. 1. Using the GUI, the human operator selects one of the containers 14 (referred to as “Bin” in FIG. 3A) and associated metering devices 16 for the look-ahead calibration. Alternatively, the computer device may be programmed by default to automatically select one of the containers 14a, 14b, 14c, or to automatically select them sequentially for look-ahead calibration. It may be desirable to perform look-ahead calibration on a container-specific basis for a variety of reasons. For example, their fan 22 and metering devices 16 may have different operating characteristics, they may be associated with distribution paths 18 of significantly different lengths, and they may store different particulate materials (e.g., seed, and fertilizer particles) that have different flow characteristics in distribution paths 18.

At step 302, the computer device presents the human operator with an interface for changing and confirming operating parameters associated with the container selected in step 300. For example, display device of tablet computer 30b may display a GUI (not shown) that permits the operator to review, input and/or confirm settings such as the type of the dispensing augers or rollers of metering devices 16 of the MDA, and their dispensing rates, and the speed of fan 22.

At step 304, the computer device checks for user confirmation of the operating parameters associated with the container, as considered in step 302. If no user confirmation is received, then the method returns to step 300 and continues until a user confirmation is received, and then proceeds to step 306.

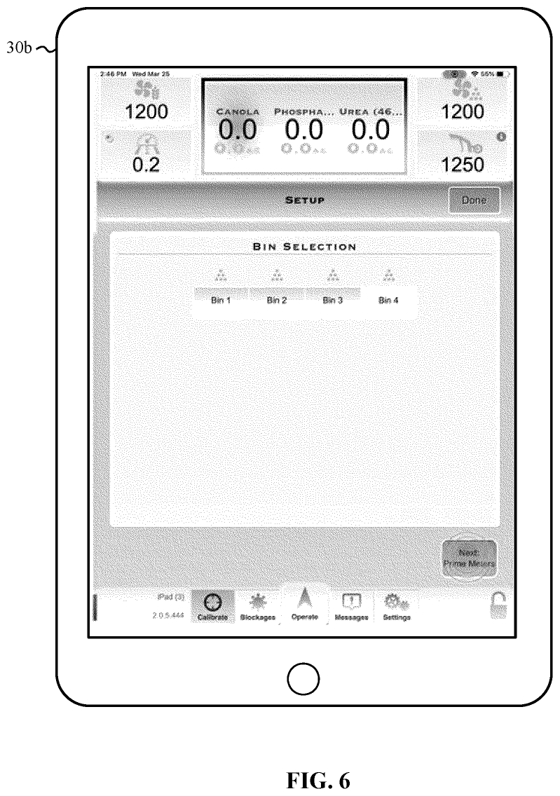

At step 306, the computer device receives a user command for priming the metering devices 16 (referred to as “Meters” in FIG. 3A). In this example, “priming” the metering devices 16 refers to engaging and then disengaging the metering devices 16 to ensure that subsequent engagement of metering devices 16 results in dispensing particulate material from container 14 into the associated distribution paths 18 without any significant latency. In this example, tablet computer 30b displays a GUI, as shown in FIG. 7, with a user-selectable button labelled “Prime Meters” for the operator to input this command.

At step 308, the computer device determines whether fan 22 is rotating at sufficient speed (e.g., greater than 1000 rpm or some other speed) for priming the metering devices 16. If fan 22 is not rotating with sufficient speed, then the method returns to step 306 and continues until fan 22 is rotating with sufficient speed, and then proceeds to step 310.

At step 310, the computer device primes metering devices 16. In this example, this involves the computer device transmitting control signals to activate augers or rollers of metering devices 16 to rotate for several cycles, while fan 22 is running.

At step 312, the computer device determines whether the flow sensors 24 (referred to as “Blockage Sensors” in FIGS. 3A and 3B) are detecting particulate material flow through their associated distribution paths 18. If the flow sensors 24 detect particulate material flow, then the flow sensors 24 are considered to be “triggered”. Failure to trigger all the flow sensors 24 indicates that at least one of the metering devices 16 is not adequately primed. If any flow sensors 24 is not triggered, then the method returns to step 310 and continues until all flow sensors 24 are triggered, and then proceeds to step 314. In the alternative, if, for example, a sensor is unresponsive and is stuck in a loop, then return to step 306 for operator input to prime the meters again.

At step 314, the computer device engages metering devices 16 (referred to as “Bin Meters” in FIG. 3B) to start dispensing particulate material from container 14 into their associated distribution paths 18. In this example, engaging the metering devices 16 involves the computer device transmitting control signals to start rotation of augers or rollers of metering devices 16. At the same time, the method starts timers 42 (referred to as a “Delay Timers” in FIG. 3B) to start measuring the “engage times” for the metering devices 16.

In this embodiment, the computer device performs look-ahead calibrations simultaneously for all metering device 16. Accordingly, each of the timers 42 measures engage time for a different one of the metering devices 16 and its associated flow sensor 24. In other embodiments, the method may perform look-ahead calibrations sequentially for the metering devices 16. In such embodiments, a single timer 42 may instead be used, and switched to measure engage time for each metering device 16 in sequence.

At step 316, the computer device determines whether the flow sensor 24 associated with each metering device 16 is detecting a particulate material flow through its associated distribution paths 18 that is greater than (above) a pre-defined starting threshold flow level (referred to as “Starting Output Threshold” in FIG. 3B). For convenient discussion, this detection is referred to the flow sensor 24 being “triggered” in the context of steps 318 to 320. For any flow sensor 24 that has not been triggered, the method returns to step 316, continues until the flow sensor 24 is triggered, and then proceeds to step 318 for that triggered flow sensor 24.

In this example, it has been assumed for simplicity that each metering device 16 is associated with only one flow sensor 24. In embodiments where each metering device 16 is associated with a flow sensor assembly (FSA) having a plurality of flow sensors 24 (e.g., the ten flow sensors 24 associated with ten seed runs of a tower as described above), the particulate material flow detected by the flow sensors 24 of the flow sensor assembly (FSA) may exhibit some deviation. In such embodiments, the computer device may average the particulate flows detected by the sensors 24 of the flow sensor assembly (FSA) for the purposes of step 316.

The pre-defined starting threshold flow level used in step 316 is stored in memory 34. The value of the pre-defined starting threshold flow level used in step 316 should indicate that the particulate material that was dispensed by engaging a metering device 16 at step 314 has started flowing through the flow sensor 24. Values that could merely indicate signal noise or presence of residual particulate material in the distribution path 18 should be avoided.

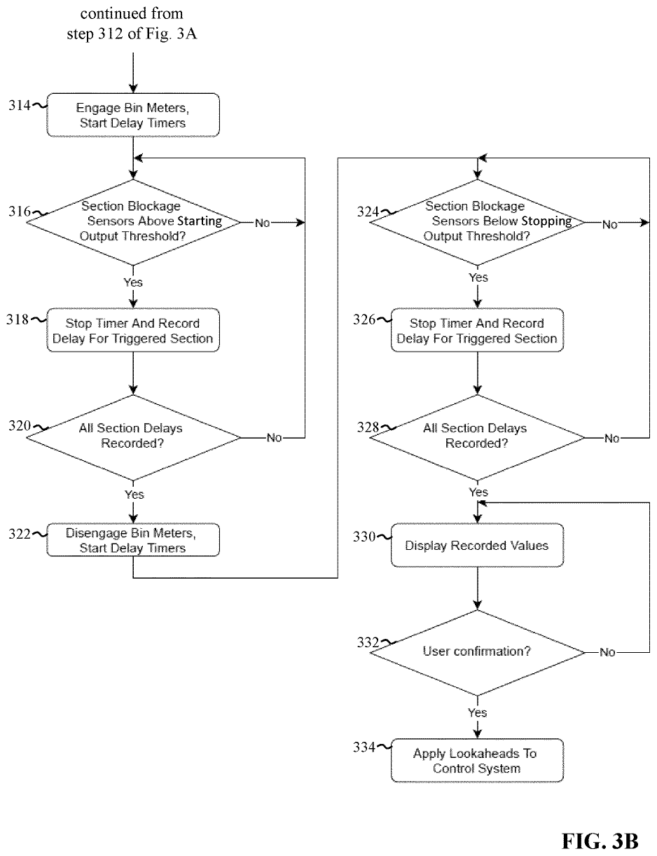

In some embodiments, the value of the starting threshold flow level may be defined automatically by the computer device, without the need for any intervention by the human operator. For example, FIG. 4 shows a subroutine for determining the value of the starting threshold flow level, which may be performed prior to step 314. At step 400, the computer device controls the fan 22 to operate a particular fan speed, and the metering devices 16 to operate at the dispensing rates selected or confirmed in step 302. At step 402, while the fan 22 and metering devices 16 are operating, the computer device monitors signals generated by the flow sensors 24 to detect maximum flow rates of particulate materials. Such maximum flow rates can be considered to be representative of a steady-state, fully developed flow of particulate material through the distribution paths. At step 404, the computer device calculates the value of the starting threshold flow level as a predetermined percentage (e.g., 90%) of this maximum flow rate. In this manner, the values of the starting threshold flow levels may be defined individually for each distribution path based on maximum flow rates detected by its associated flow sensor. Alternatively, a single value of the starting threshold flow level may be determined for all distribution paths, such as by applying the result from one distribution path for all distribution paths, or by averaging of maximum flow rates detected by all flow sensors 24. In either case, the value of the starting threshold flow level is automatically set by the computer device to suit particular operating conditions of the air seeding apparatus and a particular type of particulate material for which the look-ahead calibration is being performed.

In other embodiments, the value of the pre-defined starting threshold flow level may be “hard coded” in software—i.e., non-modifiable and prescribed by the set of instructions stored in the memory 34. In still other embodiments, the value of the pre-defined starting threshold flow level may be user modifiable using user input device 38. An appropriate value may be determined by the person of ordinary skill in the art based on empirical testing of a particular specification of air seeding apparatus 12 components, and a particular type of particulate material.

At step 318, the computer device stops the timer 42 associated with the triggered flow sensor 24 (referred to as a “Triggered Section” in FIG. 3B), and records the elapsed engage time (referred to as “Delay” in FIG. 3B) measured by that flow sensor 42 in memory 34.

At step 320, the computer device determines whether step 318 has been performed in respect to all flow sensors 24. For any flow sensor 24 for which 318 has not been performed, the method returns to step 316, and continues until step 318 has been performed in respect to all the flow sensors 24, and then proceeds to step 322.

At step 322, the computer device disengages the metering devices 16 (referred to as “Bin Meters” in FIG. 3B) to cease (stop) dispensing particulate material from container 14 into their associated distribution paths 18. For example, disengaging the metering devices 16 may involve transmitting control signals to stop rotation of augers or rollers of metering devices 16. At the same time, the method starts timers 42 to start measuring the “disengage times” for the metering devices 16.

At step 324, the computer device determines whether each of the flow sensors 24 is detecting a particulate material flow through their associated distribution paths 18 that is less than a pre-defined stopping threshold flow level (referred to as “Stopping Output Threshold” in FIG. 3B). For convenient discussion, this event is referred to the flow sensor 24 being “triggered” in the context of steps 326 and 328. For any flow sensor 24 that has not been triggered, the method returns to step 324, continues until the flow sensor 24 is triggered, and then proceeds to step 326 for that triggered flow sensor 20.

The pre-defined stopping threshold flow level used in step 324 is stored in memory 34 and may be user modifiable using user input device 38. The value of the pre-defined stopping threshold flow level used in step 324 may be the same as or different than the value of the pre-defined starting threshold flow level used in step 316. The value of the pre-defined stopping threshold flow level that is used in step 324 should be selected so as to indicate that the particulate material that was dispensed before disengaging a metering device 16 at step 322 has stopped flowing through the associated flow sensor 24.

The value(s) of the stopping threshold flow levels may be defined in analogous manners as described above for the value(s) of the starting threshold values. In some embodiments, the value of the stopping threshold level may be defined automatically by the computer device, without the need for any intervention by the human operator, in a manner analogous to defining the value of the starting threshold level used in step 316. For example, continuing the subroutine of FIG. 4, at step 406, the computer device calculates the value of the stopping threshold flow level as a predetermined percentage (e.g., 10%) of the maximum flow rate determined at step 402. In other embodiments, the value of the pre-defined stopping threshold flow level may be non-modifiable and prescribed by the set of instructions stored in the memory 34. In still other embodiments, the value of the pre-defined stopping threshold flow level may be user modifiable using user input device 38. An appropriate value may be determined by the person of ordinary skill in the art based on empirical testing of a particular specification of air seeding apparatus 12 components, and a particular type of particulate material.

At step 326, the computer device stops the timer 42 associated with the triggered flow sensor 24 (referred to as a “Triggered Section” in FIG. 3B), and records the elapsed disengage time (referred to as “Delay” in FIG. 3B) measured by that flow sensor 42 in memory 34.

At step 328, the computer device determines whether step 326 has been performed in respect to all flow sensors 24. For any flow sensor 24 for which 326 has not been performed, the method returns to step 324, continues until step 326 has been performed in respect to all the flow sensors 24, and then proceeds to step 330.

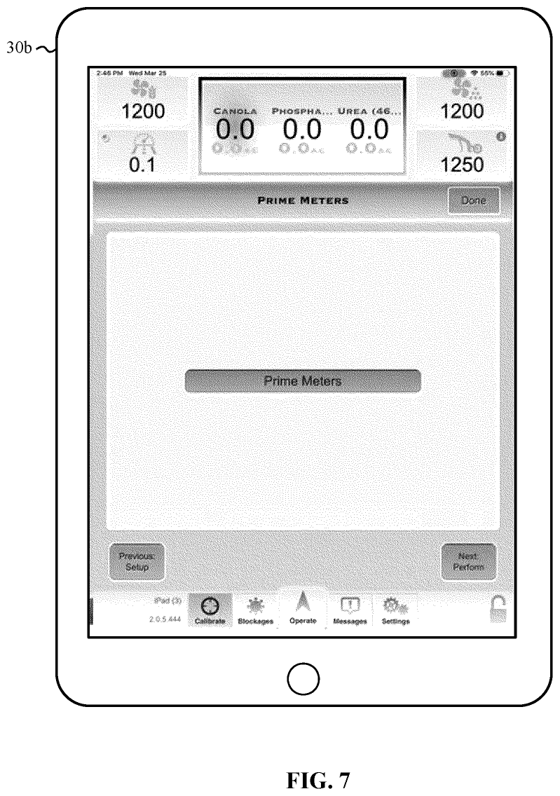

At step 330, the computer device displays the recorded engage and disengage times. In this example, display device 36 of tablet computer 30b displays a GUI, as shown in FIG. 8, with the recorded engage time (e.g., “7.32” seconds) and disengage time (e.g., “4.38” seconds) for one of the metering devices 16, but the GUI may show the engage and disengage times for any other metering device 16. For example, the GUI may show engage and disengage times for all metering device 16 in a tabular format. As another example, the GUI may show the engage and disengage time for one metering device 16, with navigation buttons to display the engage and disengage times for other metering devices 16.

In this embodiment, the GUI of FIG. 8 also shows the engage and disengage times rounded to the nearest second (e.g., 7 seconds, and −4 seconds, respectively), but other rounding intervals (e.g. 0.5 seconds) are also possible. Further, the GUI of FIG. 8 shows user-selectable buttons labelled “−” and “+” that allow the operator to manually decrement and increment the rounded engage and disengage times. For example, the operator may wish to adjust the stored sectional control algorithm based on real-world experience of using a particular air seeding apparatus 10 or to achieve a desired effect.

At step 332, the computer device checks for user confirmation of acceptance of the engage and disengage times, as may optionally be modified by the human operator. For example, the user confirmation may be received when the operator selects the user-selectable button labelled “Apply” in the GUI shown in FIG. 8. If no user confirmation is received, then the method returns to step 330 and continues until a user confirmation is received, and then proceeds to step 334.

At step 334, the computer device applies the engage and disengage times (referred to as “Lookaheads” in FIG. 3B) to the stored sectional control algorithm (referred to as “Control System” in FIG. 3B). The computer device does so by modifying one or more parameters of the stored sectional control algorithm in memory 34, based on the engage and disengage times confirmed by the operator in step 332, and storing the modified stored sectional control algorithm in memory 34. “Based on the engage and disengage times” in this context includes modifying the stored sectional control algorithms on data additional to the engage and disengage times, and/or parameters determined by post-processing of the engage and disengage times (e.g., performing mathematical operations on the engage and disengage times to derive the parameters). In subsequent use, the sectional control technology will operate in accordance with the modified stored sectional control algorithm.

The method of FIGS. 3A and 3B can then be repeated for another one of the containers 14, and its associated metering devices 16.

In the foregoing example of the look-ahead calibration method, the method involves steps of displaying information to a human operator, and taking steps condition on commands from a human operator, such as at steps 300, 302, 304, 330 and 332. Such steps are optional for other embodiments of the method of the present invention, and may be omitted or modified so that the method is performed on a fully-automated basis without any need for intervention or supervision of a human operator.

In comparison with the existing approach to look-ahead calibration described in the Background section above, the look-ahead calibration method of the present invention does not rely on human observation, judgement, or reaction time. Further, it makes look-ahead calibration practical and convenient for numerous metering devices 16 on an individualized basis, thus allowing for improved accuracy of SCTs.

### Method for Detecting and Responding to Out-of-Calibration Operation

Once the engage and disengage times have been calibrated (whether as described above, or using other methodologies), it would be desirable to detect and respond to out-of-calibration operation of the air-seeder apparatus while the air seeding apparatus is in use in the field. As used herein, “out-of-calibration operation” refers to an engage time measured during operation of the air seeding apparatus 10 differing from the stored engage time that define the sectional control algorithm, or a disengage time measured during operation of the air seeding apparatus 10 differing from the stored disengage time that defines the section control algorithm. There may also be times where an operator would only want to record the product engage time, i.e., not stop the meter after product is sensed, to simply monitor the machine during normal use. This would be useful if the operator has already performed the lookahead calibration but during field operation the product delay suddenly increases and the control system can warn the operator of abnormal operation.

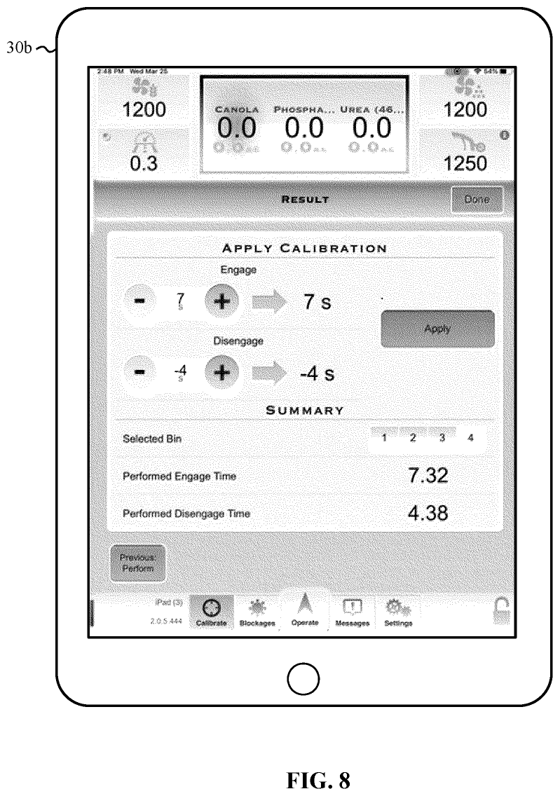

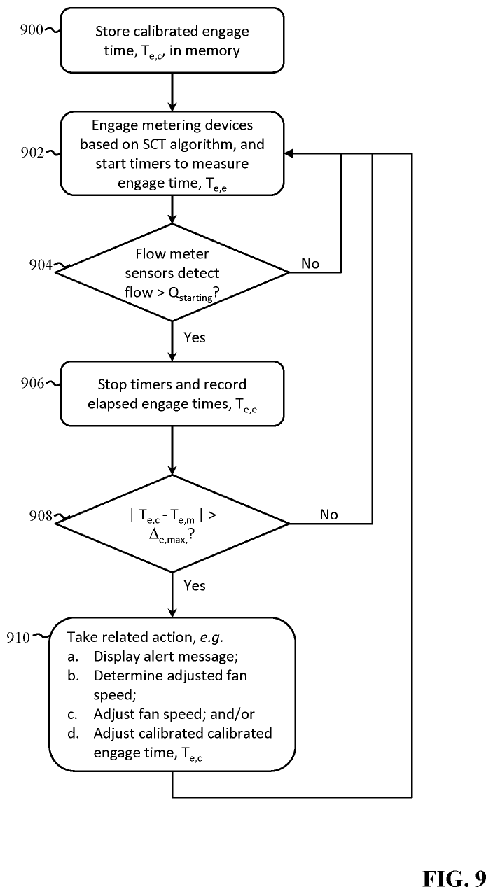

FIG. 9 shows a flowchart of a method for detecting and responding to out-of-calibration operation detection method of the present invention, based on deviation between a “stored engage time” (i.e., the expected travel time for particulate material from the metering device to the flow sensor after engaging the metering device) and an “elapsed engage time” (i.e., the engage time that is measured during use of the SCT in accordance with the SCT algorithm). FIG. 10 shows a flow chart of a method for detecting and responding to out-of-calibration operation detection method of the present invention, based on deviation between a “stored disengage time” (i.e., the expected travel time for particulate material from the metering device to the flow sensor after disengaging the metering device) and an “elapsed disengage time” (i.e., the disengage time that is measured during use of the SCT in accordance with the SCT algorithm). The steps of the methods shown in FIGS. 9 and 10 are described together below because of similarities of their steps, but it will be understood that the two methods are performed non-simultaneously and independently of each other.

At step 900, the computer device stores a stored engage time, denoted T_{e,c}, in memory. Similarly, at step 1000, the computer device stores a stored disengage time, denoted T_{d,c}, in memory. As an example, these steps may be implemented when performing step 334 of the method shown in FIG. 3B, or after the SCT algorithm has been defined in some other manner.

Steps 902-910, and 1002-1010 may be performed while the SCT of the air seeding apparatus is in use to deposit particulate material on a ground, such as during a seeding or fertilizing operation. As such, these steps may allow for detection and response to out-of-calibration operation of the SCT in “real time”—i.e., within a time of seconds or fractions of a second of occurrence of the out-of-calibration operation of the SCT.

At step 902, the SCT engages the metering devices to start dispensing particulate material on the ground. At step 1002, the SCT disengages the metering devices to cease dispensing particulate material on the ground. In steps 902 and 1002, the engagement and disengagement, respectively, of the metering devices is controlled by the stored SCT algorithm, as defined in part by the stored engage time T_{e,c} and the stored disengage time T_{d,c}, respectively.

At step 902, when the SCT engages the metering devices, the computer device starts timers 42 to start measuring an elapsed engage time T_{e,e}. Similarly, at step 1002, when the SCT disengages the metering devices, the computer devices starts timers to start measuring an elapsed disengage time T_{d,e}. In the embodiment of FIGS. 9 and 10, the computer device performs steps 902 and 1002 for each of the metering devices 16 individually, using a different timer 42 for each of the metering devices 16. In other embodiments, the computer device may activate a single timer 42, and switch it to measure engage and disengage times for each metering device 16 in sequence.

At step 904, the computer device determines whether the flow sensor 24 associated with each metering device 16 is detecting a particulate material flow through its associated distribution paths 18 that is greater than a pre-defined starting threshold flow level, Q_{starting}. At step 1004, the computer device determines whether the flow sensor 24 associated with each metering device 16 is detecting a particulate material flow through its associated distribution paths 18 that is less than a pre-defined stopping threshold flow value, Q_{stopping}. The values of Q_{starting} and Q_{stopping}, should be selected to be indicative that particulate material has started and ceased, respectively, to flow through the flow sensor; values that could be merely indicative of signal noise or presence of residual particulate material in the distribution path 18. The values of Q_{starting} and Q_{stopping} may be defined using the same approaches as described above to define the value of the pre-defined starting threshold flow level used in step 316, and the pre-defined stopping threshold flow value used in step 324, respectively. In some embodiments, they may be equated to those values used in step 316 and 324, respectively, while in other embodiments they may be different from those values.

At step 906, when the flow sensor 24 detects a particulate material flow that is greater than Q_{starting}, the computer device stops the associated timer 42, and records the measured elapsed engage time. Similarly, at step 1006, when the flow sensor 24 detects a particulate material flow that is less than Q_{stopping}, the computer device stops the associated timer 42, and records the measured elapsed disengage time.

At step 908, the computer device determines whether the values of stored engage time and the elapsed engage time deviate from each other by more than a threshold deviation value. Similarly, at step 1008, the computer device determines whether the values of stored disengage time and the elapsed disengage time deviate from each other by more than a threshold deviation value. In steps 908 and 1008, this condition being satisfied is considered to be detection of out-of-calibration operation of the air seeding apparatus.

The determination of this condition may be performed on an individual basis for each of the engage times (or disengage times) as measured for each of the flow sensors 24, or an aggregate basis for the engage times (or disengage times) as measured for all of the flow sensors 24 (e.g., by using a total or average value). In one non-limiting embodiment, the determination may involve calculating a difference between the values (e.g., |T_{e,c}-T_{e,m}| in step 908; or |T_{d,c}-T_{d,m}| in step 1008), and checking if the difference exceeds a predefined threshold deviation value (e.g., Δ_{e,max} in step 908; or Δ_{d,max} in step 1008), which may be set to a time value (e.g., less than a second, a second, or several seconds) selected for a deviation that is tolerable before taking a related action. In another non-limiting embodiment, the determination may involve calculating a ratio of the stored engage (or disengage) time and the elapsed engage (or disengage) time, and checking if the ratio exceeds a predefined deviation value (e.g., 101%, 105% or 110%) selected for a deviation that is tolerable before taking a related action. The level of deviation may be calculated in other ways.

At step 910 and step 1010, the computer device takes a related action if out-of-calibration operation of the air seeding apparatus is detected. The related action may comprise one or a combination of the following steps.

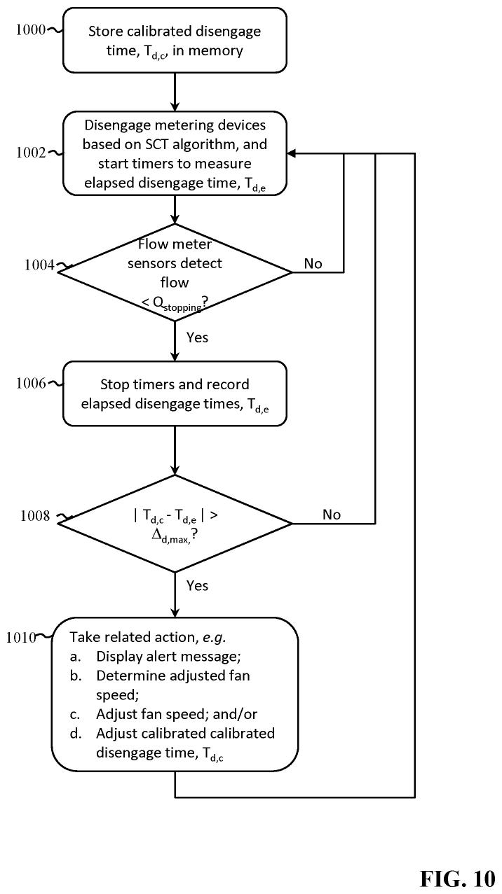

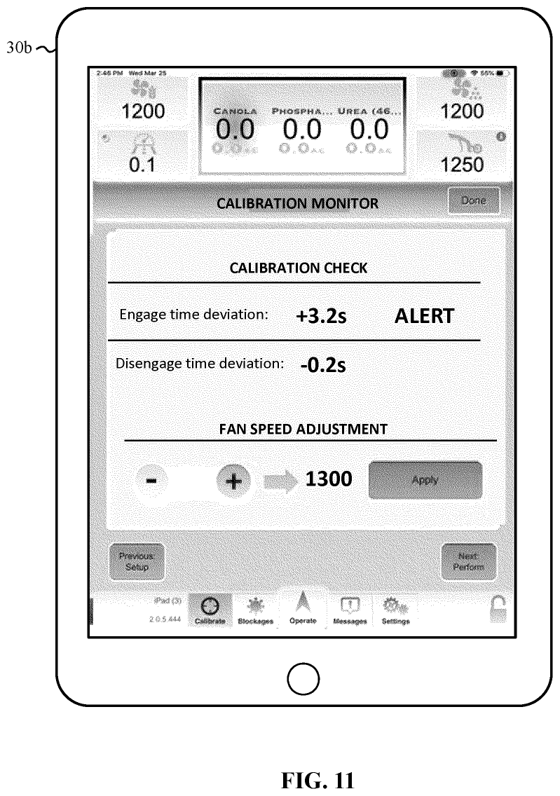

In one embodiment, the related action comprises generating a visible alert on a display screen to warn the human operator of the out-of-calibration operation of the air seeding apparatus. For example, the elapsed engage time exceeding the stored engage time by a significant degree may be indicative of abnormal operation of the air seeding apparatus. Display device 36 of tablet computer 30b may display a GUI, as shown in FIG. 11, shows the deviation between the calibrated and elapsed engage times (e.g., “Engage time deviation: +3.2 s”) and the deviation between the calibrated and elapsed disengage times (e.g., “Disengage time deviation: −0.2 s”). The significant deviation between the calibrated and elapsed engage times is indicative of out-of-calibration operation, and therefore the GUI displays an alert of the out-of-calibration operation. In FIG. 11, the alert is the text “ALERT”, but in other embodiments, the alert may be any other visible indicator such as a warning message, graphic, or change in color scheme. The alert warns the human operator of the out-of-calibration condition, so that the human operator can take remedial action such as inspecting and servicing the air seeding apparatus, or performing the look-ahead calibration process as described above.

In another embodiment, the related action comprises setting and varying the speed of the fan 22. For example, the elapsed disengage time exceeding the stored disengage time by a significant degree may mean that the particulate material is taking longer than expected to travel through the distribution path 18 from the metering device 16 to the flow sensor 24. This may be due to the particulate material having a velocity that is below the saltation velocity—i.e., the air conveying velocity below which the particulate material falls out of suspension from the air stream and settles in the conduits of the distribution path 18. A possible remedial response to this phenomenon is to increase the speed of fan 22. Accordingly, display device 36 of tablet computer 30b may display a GUI, as shown in FIG. 11, with an interface to change the speed of fan 22. In FIG. 11, this is shown under the label “Fan Speed Adjustment” with “−”, “+” and “Apply” buttons for decreasing or increasing the fan speed, and for applying that change to control the speed of fan 22. In embodiments, the GUI may display a recommendation to decrease or increase fan speed, or a particular fan speed. In other embodiments, the computer device may automatically control the speed of fan 22 according to a predefined rule stored in memory 34. For example, if the elapsed disengage time exceeds the stored disengage time, then the computer device may increase the speed of fan 22 by a fixed increment, with the objective that the elapsed disengage time converges toward the stored disengage time in subsequent operation of the air seeding apparatus.

Accordingly, the foregoing methods allow for detecting and/or responding to out-of-calibration operation of the air seeding apparatus with minimal or no human intervention.

### Interpretation

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The claimed invention is:

1. A method for look-ahead calibration of a stored sectional control algorithm for an air seeding apparatus comprising at least one metering device for dispensing particulate material from a container through an associated distribution path to at least one associated flow sensor, wherein the method is implemented by a processor operatively connected to the metering device and the flow sensor, the method comprising the steps of:
(a) controlling the metering device to start dispensing particulate material through the distribution path;
(b) measuring an elapsed engage time from step (a) until the flow sensor starts detecting particulate material flow above a starting threshold flow value;
(c) controlling the metering device to cease dispensing particulate material through the distribution path;
(d) measuring an elapsed disengage time from step (c) until the flow sensor starts detecting particulate material flow below a stopping threshold flow value; and
(e) modifying the stored sectional control algorithm based on the engaged time and the disengage time.

2. The method of claim 1, wherein the sequence of steps (a), (b) and (c) is (a), (b) and (c).

3. The method of claim 1, wherein the sequence of steps (a), (b) and (c) is (a), (c) and (b).

4. The method of claim 1, wherein the at least one metering device comprises a plurality of metering devices, wherein each of the metering devices is for dispensing particulate material from the container through a different associated distribution path to a different associated flow sensor, and wherein the method comprises performing steps (a) to (e) in respect to each of the metering devices.

5. A system for look-ahead calibration of a stored sectional control algorithm for an air seeding apparatus comprising at least one metering device for dispensing particulate material from a container through an associated distribution path to at least one associated flow sensor, the system comprising:
a processor operatively connected to the metering device and the flow sensor; and
a non-transitory computer readable medium storing a set of instructions executable by the processor to implement a method comprising the steps of:
(a) controlling the metering device to start dispensing particulate material through the distribution path;
(b) measuring an elapsed engage time from step (a) until the flow sensor starts detecting particulate material flow above a starting threshold flow value;
(c) controlling the metering device to cease dispensing particulate material through the distribution path;
(d) measuring an elapsed disengage time from step (c) until the flow sensor starts detecting particulate material flow below a stopping threshold flow value; and
(e) modifying the stored sectional control algorithm based on the engaged time and the disengage time.

6. The system of claim 5, wherein the at least one metering device comprises a plurality of metering devices, wherein each of the metering devices is for dispensing particulate material from the container through a different associated distribution path to a different associated flow sensor, and wherein the method comprises performing steps (a) to (e) in respect to each of the metering devices.

7. The system of claim 5, wherein the system further comprises the at least one flow sensor.

8. A computer program product for look-ahead calibration of a stored sectional control algorithm for an air seeding apparatus comprising at least one metering device for dispensing particulate material from a container through an associated distribution path to at least one associated flow sensor, the computer program product comprising a non-transitory computer readable medium storing a set of instructions executable by a processor operatively connected to the metering device and the flow sensor to implement a method comprising the steps of:
(a) controlling the metering device to start dispensing particulate material through the distribution path;
(b) measuring an elapsed engage time from step (a) until the flow sensor starts detecting particulate material flow above a starting threshold flow value;
(c) controlling the metering device to cease dispensing particulate material through the distribution path;
(d) measuring an elapsed disengage time from step (c) until the flow sensor starts detecting particulate material flow below a stopping threshold flow value; and
(e) modifying the stored sectional control algorithm based on the engaged time and the disengage time.

9. A method for detecting or responding to out-of-calibration operation of an air seeding apparatus comprising a metering device for dispensing particulate material from a container through an associated distribution path to a flow sensor;
wherein the metering device is controlled by a stored sectional control algorithm defined by either:
(i) a stored engage time indicative of expected travel time for particulate material through the distribution path after engaging the metering device; or
(ii) a stored disengage time indicative of expected travel time for particulate material through the distribution path after disengaging the metering device;
wherein the method is implemented by a processor operatively connected to the metering device and the flow sensor, the method comprising the steps of:
(a) either:
(i) measuring an elapsed engage time from when the sectional control algorithm engages the metering device to start dispensing particulate material through the distribution path until the flow sensor detects particulate material flow above a starting threshold flow value; or
(ii) measuring an elapsed disengage time from when the sectional control algorithm disengages the metering device to cease dispensing particulate material through the distribution path until the flow sensor detects particulate material flow below a stopping threshold flow value;
(b) taking a related action if either:
(i) the stored engage time and the elapsed engage time deviate from each other by more than a first threshold deviation value; or
(ii) the stored disengage time and the elapsed disengage time deviate from each other by more than a second threshold deviation value;
wherein the related action comprises one or a combination of:
(iii) generating a visible alert on a display screen; and
(iv) varying a speed of a fan for creating air flow through the distribution path.

10. A system for detecting or responding to out-of-calibration operation of an air seeding apparatus comprising a metering device for dispensing particulate material from a container through an associated distribution path to a flow sensor;
wherein the metering device is controlled by a stored sectional control algorithm defined by either:
(i) a stored engage time indicative of expected travel time for particulate material through the distribution path after engaging the metering device; or
(ii) a stored disengage time indicative of expected travel time for particulate material through the distribution path after disengaging the metering device;
the system comprising:
a processor operatively connected to the metering device and the flow sensor; and
a non-transitory computer readable medium storing a set of instructions executable by the processor to implement a method comprising the steps of:
(a) either:
(i) measuring an elapsed engage time from when the sectional control algorithm engages the metering device to start dispensing particulate material through the distribution path until the flow sensor detects particulate material flow above a starting threshold flow value; or
(ii) measuring an elapsed disengage time from when the sectional control algorithm disengages the metering device to cease dispensing particulate material through the distribution path until the flow sensor detects particulate material flow below a stopping threshold flow value;
(b) taking a related action if either:
(i) the stored engage time and the elapsed engage time deviate from each other by more than a first threshold deviation value; or
(ii) the stored disengage time and the elapsed disengage time deviate from each other by more than a second threshold deviation value;
wherein the related action comprises one or a combination of:
(iii) generating a visible alert on a display screen; and
(iv) varying a speed of a fan for creating air flow through the distribution path.

11. A computer program product for detecting or responding to out-of-calibration operation of an air seeding apparatus comprising a metering device for dispensing particulate material from a container through an associated distribution path to a flow sensor,
wherein the metering device is controlled by a stored sectional control algorithm defined by either:
(i) a stored engage time indicative of expected travel time for particulate material through the distribution path after engaging the metering device; or
(ii) a stored disengage time indicative of expected travel time for particulate material through the distribution path after disengaging the metering device;
the computer program product comprising a non-transitory computer readable medium storing a set of instructions executable by a processor operatively connected to the metering device and the flow sensor to implement a method comprising the steps of:
(a) either:
(i) measuring an elapsed engage time from when the sectional control algorithm engages the metering device to start dispensing particulate material through the distribution path until the flow sensor detects particulate material flow above a starting threshold flow value; or
(ii) measuring an elapsed disengage time from when the sectional control algorithm disengages the metering device to cease dispensing particulate material through the distribution path until the flow sensor detects particulate material flow below a stopping threshold flow value;
(b) taking a related action if either:
(i) the stored engage time and the elapsed engage time deviate from each other by more than a first threshold deviation value; or
(ii) the stored disengage time and the elapsed disengage time deviate from each other by more than a second threshold deviation value;
wherein the related action comprises one or a combination of:
(iii) generating a visible alert on a display screen; and
(iv) varying a speed of a fan for creating air flow through the distribution path.
